(19) United States
(12) Patent Application Publication
(10) Pub. No.: US 2008/0026609 A1
(43) Pub. Date: Jan. 31, 2008

(54) Low profile connector

(76) Inventors: Keisuke Kuwana, Tokyo (JP); Masaru Abe, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/878,589

(22) Filed: Jul. 25, 2007

(30) Foreign Application Priority Data
Jul. 31, 2006 (JP) 2006-207819

(51) Int. Cl. H01R 12/00

(52) U.S. Cl. 439/74

(57) ABSTRACT

To obtain a low profile connector that can prevent contacts from being deformed excessively when fitting of a connector plug is done so that a good feeling of clicking on the fitting is obtained and reliable fitting of the connectors is assured, the contact of the low profile connector is provided with a reinforcing protrusion to be abutted against the surface of a printed circuit board, which protruding from a neck portion of the contact extending from a base portion of the contact along a surface of the printed circuit board, between the base portion and a touch portion raised from the neck portion relative to the surface of the printed circuit board, the touch portion being in resilient contact and electrically connected with a contact of the connector plug.

### BACKGROUND OF THE INVENTION

1. Field of the Invention

The present invention relates to a low profile connector mounted, for example, on a printed circuit board and, more particularly, to a low profile connector giving the user a feeling of clicking when a connector plug is fitted into and withdrawn from a connector receptacle.

2. Related Art

In the past, electronic devices such as cell phones, digital cameras, and notebook personal computers have been reduced in thickness. With this trend, there is a demand for a further decrease in height to secure a sufficient effective area in fitting together connectors mounted on printed circuit boards.

For example, a known low profile connector has a substantially L-shaped insulator, a conductor, a convex portion, and a concave portion (see JP-A-09-73959). The conductor has electrode portions which are to be contacted with electrode portions of a mating low profile connector and which are pulled in groove portions formed in one L-shaped inner surface of the insulator. Engagement portions extend from the electrode portions of this conductor and are fixed to openings in a support body that are continuous with the groove portions. The conductor has terminal portions extending from the engagement portions. The convex and concave portions that fitly engage the concave and convex portions, respectively, of the mating low profile connector are formed in both ends of the surface in which the groove portions of the insulator are formed.

Another known low profile connector includes a housing having a fitting portion into which a flexible printed circuit board is inserted (see JP-A-2005-141956). Contacts protrude from the housing and are arranged parallel to a hard substrate or to the flexible printed circuit board. The contacts have touch portions on the sides of the hard substrate or flexible printed circuit board. At least the portions protruding from the touch portions or from the housing are not covered with the housing.

However, in the low profile connector described in the above-cited JP-A-09-73959, the insulator shaped like the letter L is fitted into the mating connector while making the insulator in a parallel relation to the printed circuit board and sliding the insulator. Therefore, space is necessary in the direction of the movement for fitting engagement around the connector. The effective space is reduced compared with the vertical type in which the insulator is moved in a direction perpendicular to the plane of the printed circuit board for fitting engagement. This is disadvantageous for high-density packaging. In the connector described in the above-cited JP-A-2005-141956, a flexible printed circuit board or flexible cable is inserted into connectors mounted to the printed circuit board while placing the flexible printed circuit board or flexible cable in a parallel relation to the printed circuit board. Again, a space in which electronic parts cannot be arranged is required to be secured around the connector. Hence, the effective space is smaller than the vertical type. Accordingly, as shown in FIGS. 7A and 7B, a vertical type connector receptacle 20 and a connector plug 21 which are mounted on a printed circuit board 19 are formed.

However, as shown in FIG. 8, in an attempt to reduce the height H of the whole connector, if the connector plug 21 is almost fully received in one connector receptacle 20 when the connector receptacle 20 and connector plug 21 are fitted together, a thickness “t” of a neck portion 22c of a contacts 22 of the connector receptacle 20 is reduced further. Furthermore, a distance L1 from a base portion 22a to a touch portion 22b to secure a space for receiving the connector plug 21 is increased. That is, as shown in FIG. 7A, the relationship L1>L2 holds, where L2 is the distance between the base portion and the touch portion of an incompletely received contact 22 that is only a part of the connector plug.

Therefore, the resistance of the contacts 22 to deformation becomes insufficient (i.e., the contacts become fragile). As shown in FIG. 8, when the contact plug 21 is mounted, if a clicking protrusion 23b of a touch portion 23a of a contact 23 of the connector plug 21 abuts against the touch portion 22b of the contact 22 of the connector receptacle 20, the contact 22 bends downward, producing deformation. Consequently, the contact portion may pass over the protrusion 23b. As a result, there is the danger that normal fitted condition cannot be obtained.

Furthermore, as shown in FIG. 9, when the connector plug 21 is withdrawn from the connector receptacle 20, there is the danger that the protrusion 23b of the contact 23 on the side of the connector plug 21 becomes caught on the touch portion 22b of the contact 22 of the connector receptacle 20, whereby disengagement is not achieved. If so, a long neck portion 22c of the contact 22 is raised upward and deformed. Where a low profile connector is built from the vertical type connector in this way, the neck portion 22c of the contact 22 becomes too long. Furthermore, the thickness “t” is small. Therefore, there is the problem that the intensity of resistance to deformation necessary to obtain normal contacted state is insufficient. In addition, in the vertical type contact of the low profile connector, the portions of the contact fitted together are very short and so if an external force is applied due to vibration occurring when the connector is dropped, the contacts fitted together are disconnected from each other. Consequently, there is the problem that the connector comes out of the fitted state.

### SUMMARY OF THE INVENTION

A low profile connector of the present invention has been proposed to solve these problems.

A low profile connector of the present invention achieves the above-described object and has a connector receptacle mounted on a printed circuit board, the receptacle having contacts. Each of the contacts has a base portion firmly mounted to a housing of the connector receptacle and electrically connected with the printed circuit board, a neck portion extending from the base portion along a surface of the printed circuit board, and a touch portion raised from the neck portion relative to the surface of the printed circuit board. The touch portion is in resilient contact and electrically connected with a contact of a connector plug. The contact of the connector receptacle is provided with a reinforcing protrusion to be abutted against the surface of the printed circuit board, which protruding from the neck portion located between the base portion and the touch portion.

Preferably, alternate ones of the adjacent reinforcing protrusions of the contacts mounted parallel to each other are firmly fixed to the printed circuit board.

According to the low profile connector of the present invention, the provision of the protruding reinforcing protrusions abutted against the surface of the printed circuit board prevents excessive deformation when the connectors are fitted together or disconnected from each other. This assures that the contacts can be fitted together or disconnected from each other in a normal manner. Furthermore, the protrusions of the touch portions of the contacts produce a feeling of clicking when the connectors are fitted together. Consequently, the user can certainly know that they have been fitted together reliably.

Furthermore, alternate ones of the reinforcing protrusions of the contacts mounted parallel to each other and adjacent to each other are firmly fixed to the printed circuit board in a so-called zigzag pattern. Consequently, the contacts can be firmly bonded to the printed circuit board by soldering even within a narrow space.

### BRIEF DESCRIPTION OF THE DRAWINGS

FIG. 1A is a vertical cross section showing a low profile connector according to one embodiment of the present invention;

FIG. 1B is a vertical cross section showing a connector plug according to one embodiment of the invention;

FIG. 2A is a side elevation showing two kinds of contacts of the low profile connector;

FIG. 2B is an explanatory view showing an arrangement of pads on a printed circuit board;

FIG. 3 is a fragmentary vertical cross section showing a state in which the low profile connector and the connector plug are fitted together;

FIG. 4 is a vertical cross section showing a state in which the low profile connector is used;

FIG. 5 is a vertical cross section showing deformation of contacts caused when the low profile connector is being withdrawn in a case where reinforcing protrusions of the connector are soldered to a printed circuit board;

FIG. 6 is a vertical cross section similar to FIG. 5 but in which the reinforcing protrusions are not soldered to the printed circuit board;

FIG. 7A is a vertical cross section of a connector receptacle over which a connector plug is fitted, the plug and receptacle being designed by one prior art technique;

FIG. 7B is a perspective view showing the manner in which the connector receptacle and the connector plug shown in FIG. 7A are fitted together;

FIG. 8 is a vertical cross section showing the manner in which the connector receptacle and the connector plug shown in FIGS. 7A and 7B are in an incompletely locked state; and

FIG. 9 is a vertical cross section showing deformation of the neck portion of each contact when the connector plug shown in FIGS. 7A, 7B, and 8 is withdrawn from the connector receptacle.

### DETAILED DESCRIPTION OF THE PREFERRED EMBODIMENTS

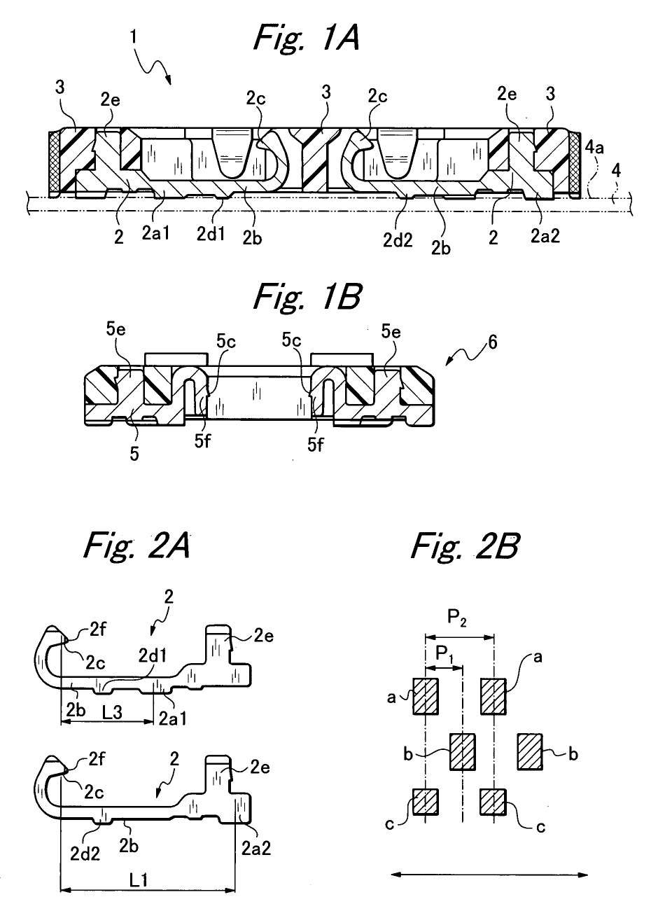

Referring to FIG. 1A, a low profile connector according to the present invention is generally indicated by reference numeral 1 and is a low profile connector receptacle mounted on a printed circuit board 4. The connector receptacle 1 has plural contacts 2 juxtaposed with each other. The contacts 2 come into contact with the surface of the printed circuit board 4 on which the receptacle 1 is mounted.

Each of the contacts 2 is composed of a base portion 2a1 or 2a2 firmly fixed to an insulating housing 3 of the connector receptacle 1 and electrically connected with the printed circuit board 4, a neck portion 2b extending from the base portion 2a1 or 2a2 along the surface 4a of the printed circuit board, and a touch portion 2c raised from the neck portion 2b relative to the surface 4a of the printed circuit board. The touch portion 2c is in resilient contact with a contact 5 of a connector plug 6 shown in FIG. 1B and electrically connected with the contact 5.

As shown in FIG. 2A, the neck portion 2b of each contact 2 located between the base portion 2a1 or 2a2 and a touch portion 2c has a reinforcing protrusion 2d1 or 2d2 that is abutted against the surface 4a of the printed circuit board. Because a distance L3 between the base portion 2a1 and the touch portion 2c is smaller than a distance L1 between the touch portion 2c and the base portion 2a2, the reinforcing protrusion 2d1 of the base portion 2a1 is mechanically strong. Therefore, during withdrawal, if the contact is pulled upward, it is less deformed. Consequently, the contact is not bonded to the printed circuit board 4 by soldering.

On the other hand, the reinforcing protrusion 2d2 of the base portion 2a2 is easily bendable because the distance L1 between the base portion 2a2 and the touch portion 2c is very large. During withdrawal, when the contact is pulled upward, it is deformed greatly. Therefore, as shown in FIG. 2B, pads “c” are mounted on the printed circuit board 4 and the contact is firmly mounted by soldering.

The contacts 2 are arranged at a reduced pitch in the direction of array as indicated by the arrows in FIG. 2B. Therefore, pads “a” and “b” are arranged in a zigzag pattern in the direction of array of the contacts 2, and the base portions 2a1 and 2a2 are arranged in a zigzag pattern, to prevent the pads on the printed circuit board 4 to which the base portions 2a1 and 2a2 are soldered from being located too closely; otherwise, the solder would bridge between the adjacent pads. The pads “a” correspond to the base portion 2a2. The pads “b” correspond to the base portion 2a1.

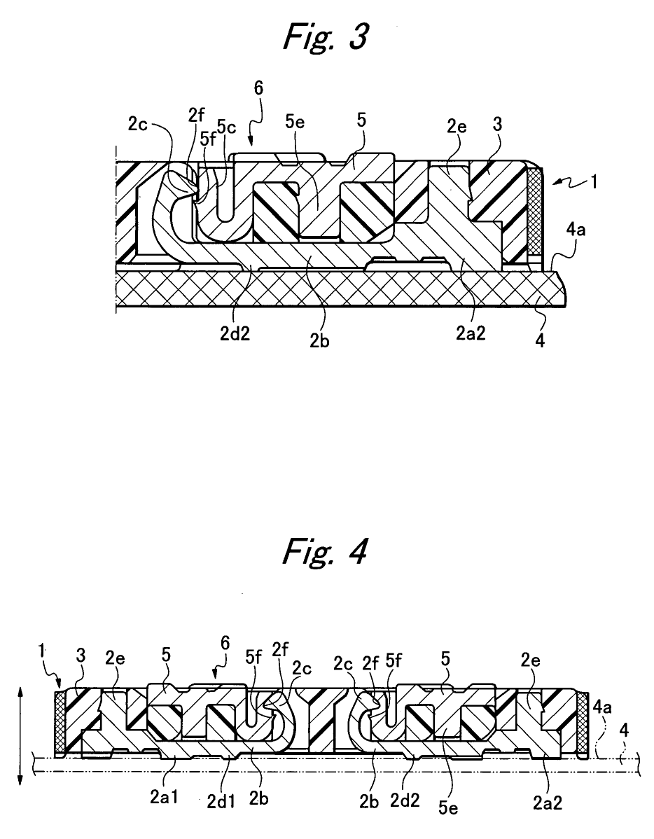

In this way, with respect to the reinforcing protrusions 2d1 and 2d2, alternate ones of the reinforcing protrusions 2d2 of the adjacent contacts 2 of the profile connector 1 where the plural contacts 2 are arranged parallel to each other as shown in FIG. 2A are firmly bonded to the printed circuit board. As shown in FIG. 3, indicated by 2e in the contact 2 is fixing portions to be mounted with a press fit into the housing 3. The connector plug 6 has a touch portion 5c that makes contact with the contact 5. The plug 6 also has a stationary portion 5e.

Where the low profile connector 1 constructed as described so far is used, as shown in FIG. 4, when the connector plug 6 is mounted, for example, to the low profile connector 1 mounted on the printed circuit board 4, the touch portions 2c of the contacts 2 make sliding contact with the touch portions 5c of the mating contact 5 and are pushed downward. The reinforcing protrusions 2d1 and 2d2 bear against the surface 4a of the printed circuit board, and a reaction force can be obtained. The intensity of resistance to deformation of the contacts 2 is increased. The amount of deformation is reduced. The state of fitting is improved. Furthermore, the protrusions 2f and 5f with which the contacts 2 and 5 come into contact pass over each other in the direction of movement for achieving fitting. Consequently, a good feeling of clicking is obtained.

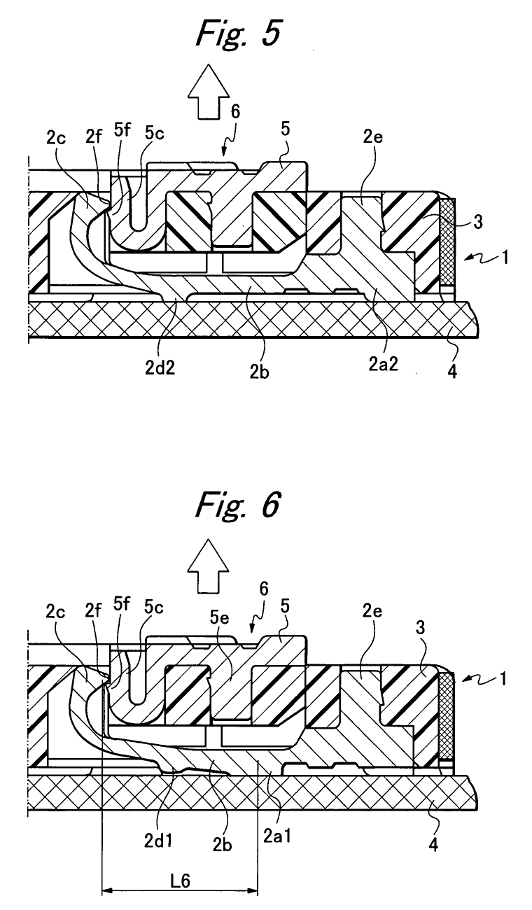

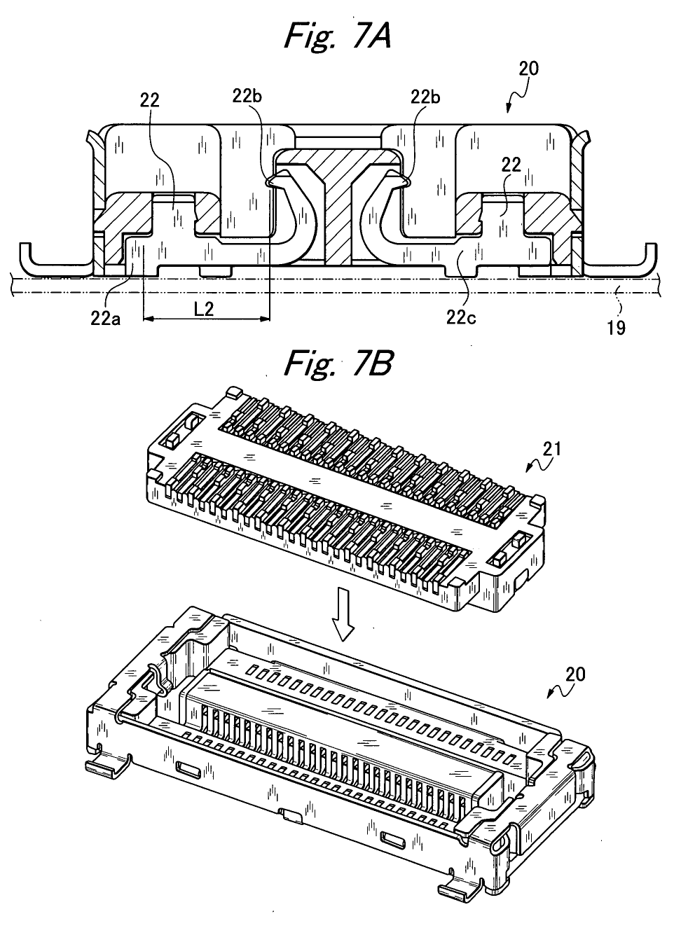

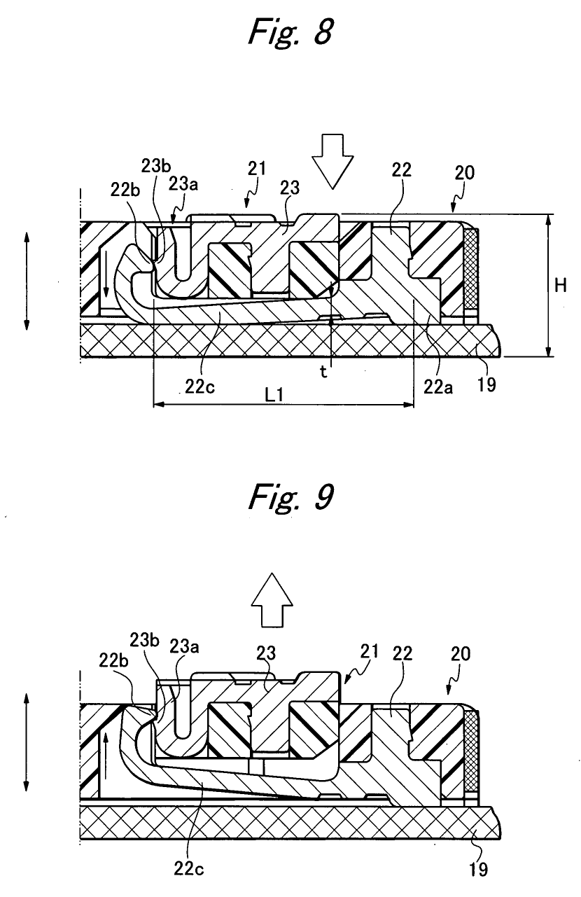

In addition, as shown in FIG. 5, the protrusions 2f and 5f of the connector receptacle 1 and connector plug 6 are in abutment with each other in the direction of withdrawal. Since the strength of the neck portions 2b of the contacts 2 are reinforced, the contacts 2 and 5 are less likely to be disengaged from each other even when dropped.

Where the connector plug 6 is withdrawn, as shown in FIG. 5, with respect to the contact 2 whose reinforcing protrusion 2d2 is soldered to the printed circuit board 4, the distance to the touch portion 2c is small. The strength of the resistance to deformation is large. Accordingly, the amount of upward flexure is small and the amount of deformation is small. On the other hand, as shown in FIG. 6, with respect to the contact 2 whose reinforcing protrusion 2d1 is not soldered to the printed circuit board 4, if the protrusions 2f and 5f of the touch portions 2c and 5c bear against their mating members during withdrawal, the neck portion 2b is raised upward. Since the distance L6 between the base portion 2a1 and the touch portion 2c is relatively small, excessive deformation does not take place. Also, in this case, the protrusions 2f and 5f pass over each other in the direction of withdrawal, and a feeling of clicking is obtained.

What is claimed is:

1. A low profile connector comprising a connector receptacle mounted on a printed circuit board, said receptacle having contacts,
wherein each of said contacts has a base portion firmly mounted to a housing of the connector receptacle and electrically connected with the printed circuit board, a neck portion extending from the base portion along a surface of the printed circuit board, and a touch portion raised from the neck portion relative to the surface of the printed circuit board, the touch portion being in resilient contact and electrically connected with a contact of a connector plug, and
wherein the contact of the connector receptacle is provided with a reinforcing protrusion to be abutted against the surface of the printed circuit board, which protruding from the neck portion located between the base portion and the touch portion.

2. A low profile connector as set forth in claim 1, wherein alternate ones of the adjacent reinforcing protrusions of the contacts mounted parallel to each other are firmly fixed to the printed circuit board.
